(19) United States
(12) Patent Application Publication
(10) Pub. No.: US 2013/0059169 A1
(43) Pub. Date: Mar. 7, 2013

(54) HIGH EFFICIENCY MICROBIAL FUEL CELL

(71) Applicants: Sten A. Wallin, Oberrieden (CH); Scott T. Matteucci, Midland, MI (US)

(72) Inventors: Sten A. Wallin, Oberrieden (CH); Scott T. Matteucci, Midland, MI (US)

(73) Assignee: DOW GLOBAL TECHNOLOGIES LLC, Midland, MI (US)

(21) Appl. No.: 13/643,187

(22) PCT Filed: Mar. 18, 2011
(86) PCT No.: PCT/US11/28963

§ 371 Date: Oct. 24, 2012

Related U.S. Application Data
(60) Provisional application No. 61/315,548, filed on Mar. 19, 2010.

(51) Int. Cl. H01M 8/16

(52) U.S. Cl. 429/2

(57) ABSTRACT

The present invention is directed to a microbial fuel cell comprising: A) an anode containing one or more conductive materials which is arranged to provide flow paths for electrons through the conductive material and to form flow paths for fluid material through passages formed in the conductive material, B) electrogenic microbes in electrical contact with the anode. C) biodegradable material disposed in a fluid, D) a cathode containing one or more conductive materials adapted such that the cathode can be contacted with an oxygen containing gas, E) an anion exchange membrane disposed between the anode and the cathode; and, F) a conduit for electrons which forms a circuit in contact with both the anode and the cathode.

### CROSS REFERENCE TO RELATED APPLICATIONS

This application claims priority from U.S. Provisional Application Ser. No. 61/315,548 filed Mar. 19, 2010 titled HIGH EFFICIENCY MICROBIAL FUEL CELL, incorporated herein by reference.

### FIELD OF THE INVENTION

The present invention relates to microbial fuel cells and improved anodes for use in microbial fuel cells. The present invention further relates to processes for producing electricity from fluids containing biodegradable materials, such as waste water. In addition, the present invention relates to processes for removing biodegradable materials from fluids containing biodegradable materials, such as waste water.

### BACKGROUND

Microbial fuel cells are well known. Patents disclosing and claiming processes for producing electricity in a combustion free environment and using microbial fuel cells to remove organic contaminants from water granted in the 1960's, see Davis et al. U.S. Pat. No. 3,331,705; Davis et al. U.S. Pat. No. 3,301,705 and Helmuth U.S. Pat. No. 3,340,094. Generally, microbial fuel cells function by contacting a fluid containing a biodegradable material, such as a waste water stream, with microbes which catalyze the decomposition of biodegradable materials in the presence of an anode. The source of the waste water streams may include streams from commercial or industrial processes or from water treatment plants. The microbes generate byproducts including electrons. The electrons are transferred from the microbe to the anode. The anode is in contact with a cathode by means of both an electron conduit and an ion conduit. The electrons are conducted by the electron conduit from the anode to the cathode. This is typically an external circuit. The electrons are driven from anode to cathode by the electrical potential difference (i.e. voltage) between the cathode and anode. With a suitable load placed in an external circuit, the electrical energy between the anode and the cathode a portion of the energy generated can be captured and used for other purposes. In order to maintain electroneutrality, the flow of electrons from anode to cathode most be accompanied by a flow of ions as well. Either cations will move from anode to cathode, or anions will move from cathode to anode, or both cations and anions will move between anode and cathode. The ions are conducted by an ion conduit. Ideally, the ion conduit is ionically conductive and electrically non-conductive. The microbes catalyze the decomposition of simple and complex organic materials to water, hydrogen ions (protons) and carbon dioxide and in the process of the decomposition generate electrons. Typical fuel cells have common features including: an electron donor, the fuel, is oxidized at the anode, which is a conductive solid that accepts the electrons from the donor, in microbial fuel cells the fuel is biodegradable material; a catalyst is needed to carry out the oxidation at the anode, in microbial fuel cells bacteria function as the catalyst; the electrons move through an electrical conduit typically through an external conduit from the anode to the cathode, which is another conductive solid; at the cathode, the electrons are added to an electron acceptor, usually oxygen; and either cations, such as protons (H⁺), sodium ions (Na⁺), potassium ions (K⁺), move separately from the anode to the cathode or anions, such as hydroxide ions (OH⁻), chloride ions (Cl⁻) move from the cathode to the anode to maintain electroneutrality in the anode compartment. As electrons flow from the anode to the cathode through an external circuit, ions must also move between the anode and the cathode to maintain electrical neutrality. Failure to move the hydrogen ions from the anode compartment or hydroxide ions to the anode compartment can result in acidification of the anode compartment and a pH gradient between the compartments. The use of microbes or other biological catalysts in the anodic compartment of a microbial fuel cell normally requires a near neutral pH. The practical effect of the pH gradient is a drop in voltage efficiency, which consequently decreases power generation. Rittmann et al WO 2010/008836 addresses this issue by adding carbon dioxide to the cathode compartment.

Microbial fuel cells provide the promise of environmentally friendly power generation and fluid purification and also present several technical challenges in addition to the pH gradient problem noted above. Waste water is a common fluid containing biodegradable material that can be purified using microbial fuel cells. Most waste water streams have limited conductivity which inhibits the transmission of ions between the cathode and the anode. In test systems buffers, such as phosphates, are added to the water to both improve conductivity and to minimize the pH change due to acidification of the water in the vicinity of the anode. It is preferable to avoid the use of buffers in microbial fuel cells. Therefore there is a need for microbial fuel cells and processes utilizing microbial fuel cells which do not require the addition of buffers. Typical cathodes used in microbial fuels cells utilize noble metals, with platinum being preferred, as catalysts. Noble metals are very expensive and impact the cost effectiveness of microbial fuel cells. Microbial fuel cells also require an oxidation agent at the cathode in order for the system to be in electrical and chemical balance. Many test systems use ferricyanide as the catholyte, oxidation agent. Microbial fuel cells having such an oxidation agent are not environmentally friendly nor are they economically sustainable. Microbial fuel cells present a very sensitive chemical environment wherein each change to the environment can prevent the system from functioning in an optimal manner or from functioning at all. All of the above described problems need to be properly addressed in a manner such that microbial fuel cells can function at high efficiencies before commercial systems can be realized. Microbial fuel cells, like all other fuel cells, convert chemical energy into electrical energy. The voltage obtained from an operating cell is less than the theoretical value. The difference between the theoretical cell voltage and the actual operational cell voltage results from four major sources of loss, as described by Larminie and Dicks, “Fuel Cell Systems Explained”; activation losses, fuel crossover and internal currents, ohmic losses and mass transport (or concentration) losses. Activation losses are caused by the slowness of the reactions taking place on the surface of the electrode. Fuel crossover and internal currents result from leakage of fuel from anode to cathode or oxidant from cathode to anode, and from electron conduction through the ion conduit. Ohmic losses result from the voltage drop due to the straightforward resistance to the flow of electrons through the materials of the electrodes and the various interconnections and electron conduits as well as the resistance to the flow of ions through the electrolyte and the ion conduit. Mass transport or concentration losses result from the change in the concentration of the reactants at the surface of the electrodes as the fuel is used. Because the reduction in concentration is the result of a failure to transport sufficient reactant to the electrode surface, this type of loss is also often call “mass transport” loss.

What is needed is an oxidation agent at the cathode which is environmentally friendly which also is an efficient oxidation agent. What are needed are microbial fuel cells that address the above described problems in a manner such that microbial fuel cells can be utilized in commercial environment. What are needed are microbial fuel cells and processes for utilizing such fuel cells which address the pH gradient issue, which are cost effective, which do not require the use of a buffer in the system, which minimize ohmic losses and mass transfer losses and which utilize an environmentally friendly and efficient oxidation agent.

### SUMMARY OF THE INVENTION

In a first embodiment the present invention relates to microbial fuel cell comprising: a microbial fuel cell comprising: A) an anode containing one or more electrically conductive materials which is arranged to provide flow paths for electrons through the electrically conductive material and to form flow paths for fluid material through passages formed in the electrically conductive material, B) electrogenic microbes in electrical contact with the anode; C) a cathode containing one or more electrically conductive materials adapted such that the cathode can be contacted with an oxygen containing fluid (gas), D) an anion exchange membrane disposed between the anode and the cathode the membrane having two opposing faces; E) a conduit for electrons which forms a circuit in contact with both the anode and the cathode; and F) a means for introducing fluid material to the anode wherein the fluid flows through the anode in a direction substantially parallel to one of the faces of the ion exchange membrane. The microbial fuel cell is adapted to be utilized with biodegradable material disposed in a fluid. In use the microbial fuel cell contains biodegradable material disposed in a fluid. In one preferred embodiment the microbial fuel cell has one or both of the anode and the cathode located in a sealed chamber. In another embodiment, the microbial fuel cell has the anode disposed in an anode chamber wherein the chamber has an inlet adapted to introduce a fluid containing biodegradable material and an outlet for removing fluid from the chamber. In yet another embodiment, the invention is a microbial fuel cell wherein the cathode is in a cathode chamber wherein the cathode chamber further contains an oxygen containing gas. Preferably, the microbial fuel cell has the cathode chamber adapted to introduce an oxygen containing gas into the chamber so as to place the oxygen containing gas in contact with the cathode. In another preferred embodiment, the cathode chamber of the microbial fuel cell is sealed to prevent the fluid containing biodegradable material from entering the cathode chamber from outside of the microbial fuel cell. In another preferred embodiment, the microbial fuel cell is adapted to be placed in a container of fluid containing biodegradable material. In another preferred embodiment the anode chamber of the microbial fuel cell is sealed to prevent fluids, other than the fluid containing biodegradable material from entering the anode chamber from the outside of the microbial fuel cell. In yet another preferred embodiment the cathode of the microbial fuel cell is open to the atmosphere. In a preferred embodiment, microbial fuel cells according to the invention have cathodes further containing a catalyst for the reduction of oxygen. In another preferred embodiment, the anode and/or the cathode are disposed adjacent to the anion exchange membrane.

In another embodiment, the invention relates to a microbial fuel cell comprising an anode, a cathode, microbes in contact with the anode, a conduit for electrons connecting the anode to the cathode through an external circuit wherein the anode comprises a mixture of one or more electrically conductive materials and one or more ion exchange materials. Preferably the electrically conductive material forms a path for electrons to flow to the electron conduit. Preferably, the ion exchange materials form a path for enhanced flow of ions to flow to the cathode and functions as an ionically conductive material.

A microbial fuel cell comprising
A) an anode containing one or more electrically conductive materials which is arranged to provide flow paths for electrons through the electrically conductive material and to form flow paths for fluid material through passages formed in the electrically conductive material,
B) electrogenic microbes in electrical contact with the anode;
C) a cathode containing one or more conductive materials adapted such that the cathode can be contacted with an oxygen containing gas;
D) a separator disposed between the anode and the cathode having two opposing faces;
E) a conduit for electrons which forms a circuit in contact with both the anode and the cathode; and,
F) a means for introducing fluid material to the anode wherein the fluid flows through the anode in a direction substantially parallel to one of the faces of the separator. The microbial fuel cell is adapted to be utilized with biodegradable material disposed in a fluid. In use the microbial fuel cell contains biodegradable material disposed in a fluid. Preferably, the anode or cathode both are disposed on one of the faces of the separator. In a more preferred embodiment, the anode and cathode are disposed on opposing faces of the separator.

In another embodiment the invention relates to a process comprising A) providing a microbial fuel cell as described hereinbefore: B) introducing a fluid containing biodegradable material into the anode chamber; C) contacting the fluid containing biodegradable material with the anode in the presence of microbes; D) introducing into the cathode chamber an oxygen containing gas; and E) removing from the anode chamber the fluid. Preferably, the fluid containing the biodegradable material is flowed continuously into through and out of the anode chamber and the oxygen containing gas is flowed continuously into, through and out of the cathode chamber. Preferably the fluid containing biodegradable material is flowed through the anode in a direction parallel to a separator disposed between the anode and the cathode. In one embodiment, the conduit for electrons is connected to an external circuit comprising one or more of a battery, device that uses electricity or a power grid.

It should be appreciated that the above referenced aspects and examples are non-limiting, as others exist within the present invention, as shown and described herein. The microbial fuel cells and processes for utilizing the microbial fuel cells of the invention facilitate the use of fluids having a low conductivity in such fuel cells without the need for a buffer. The fuel cells and processes of the invention facilitate efficient production of energy from fluids containing biodegradable materials and efficient removal of biodegradable materials from fluids in an environmentally friendly manner. The microbial fuel cells of the invention may be operated in a fashion such that appreciable acidification of the fluid is avoided. The microbial fuel cells of the invention do not require the use of undesirable chemical as oxidants. The microbial fuel cells can be operated at low noble metal loading levels and demonstrate high current densities such as greater than 10 A/m² and most preferably about 15 A/m² or greater. The microbial fuel cells of the invention with feed streams having a low or no buffering capacity demonstrate high current densities such as about 3 A/m² or greater, more preferably 7 A/m² or greater and most preferably about 15 A/m² or greater. The microbial fuel cells of the invention with feed streams having low conductivity demonstrate high current densities such as about 3 A/m² or greater, more preferably 7 A/m² or greater and most preferably about 15 A/m² or greater. The microbial fuel cells of the invention and processes of the invention reduce the ohmic losses, (particularly due to ion transport) and the mass transfer losses. The use of a porous anode provides a high effective surface area to maximize the number of electrogenic microbes in contact with the anode. The use of an anion exchange membrane in combination with the oxygen-reducing cathode provides a means of preventing the acidification of the anode compartment as the hydroxide ions produced at the cathode are transported through the anion exchange membrane to the anode compartment. Effective delivery of the biodegradable organic fuel compounds to the microbes on the anode and the effective removal of their oxidation products from the microbes on the anode is achieved by flowing the fluid through the porous anode in a direction substantially parallel to a face of the ion exchange membrane.

### DESCRIPTION OF THE DRAWINGS

FIG. 1 is an illustration of a microbial fuel cell.

FIG. 2 is an illustration of the outside of a microbial fuel cell.

FIG. 3 is a second embodiment of a microbial fuel cell.

FIG. 4 is a third embodiment of a microbial fuel cell.

FIG. 5 is a fourth embodiment of a microbial fuel cell.

FIG. 6 is a three dimensional view of a sheet-like anode chamber in combination with a cathode and a separator.

FIG. 7 is a plot of the cell voltage, V, against current density A/m² of a microbial fuel cell.

FIG. 8 is a plot of power density versus current density of a microbial fuel cell.

FIG. 9 is a plot of the cell voltage, V, against current density A/m² of a microbial fuel cell.

FIG. 10 is a plot of power density, W/m² versus current density, A/m² of a microbial fuel cell.

FIG. 11 is a plot of the cell voltage, V, against current density A/m² of a microbial fuel cell.

FIG. 12 is a plot of power density, W/m², versus current density, A/m² of a microbial fuel cell.

FIG. 13 is a plot of the cell voltage versus the current density for cells with Anodes 1 to 4.

FIG. 14 is a plot of cell voltage to current density for Anodes 1 to 4

FIG. 15 is a bar graph of the cell resistance from P curve and the cell resistance from V cell for Anodes 1 to 4.

FIG. 16 shows a plot of the cell voltage versus the current density for cells with Anodes 1, 2 and 5 at K=1 mS/em and at 4.6 mS/cm.

FIG. 17 shows the plot of power density versus current density for Anodes 1, 2 and 5.

FIG. 18 is a bar graph of the cell resistance from P curve and the cell resistance from V cell for Anodes 1, 2 and 5.

### DETAILED DESCRIPTION OF THE PREFERRED EMBODIMENT

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. It is contemplated that the various features described in the claims can be utilized in combinations of any two or more of the features. Each of the components introduced above will be further detailed in the paragraphs below and in descriptions of illustrative examples/embodiments. Other combinations are also possible as will be gleaned from the following claims, which are also hereby incorporated by reference into this written description.

The present invention is directed to a unique solution for efficient microbial fuel cells and processes utilizing such fuel cells to generate electricity and/or remove biodegradable materials from fluids.

As used herein the conductive means that the designated material enhances or facilitates the flow of designated matter therethrough, such as ions or electrons. Electrically conductive means the designated material enhances or facilitates the flow of electrons through the designated material. Ionically conductive means the designated material enhances or facilitates the flow of ions through the designated material.

The anode is adapted to be contacted with a fluid containing a biodegradable material. The anode can be placed in a container containing such fluids or can be contained in a chamber, an anode chamber. In the embodiment wherein the anode is disposed in an anode chamber, the anode chamber functions to contain the anode, the microbes and the fluid containing the biodegradable material. The anode chamber may be fabricated from any material that is compatible with the anode, the microbes and the fluid containing the biodegradable material. In a preferred embodiment, the anode chamber may be fabricated from a rigid plastic material. Preferred plastics from which the anode chamber may be fabricated include polyvinyl chlorides, polyolefins, acrylics, polycarbonates, styrenics and blends thereof including polycarbonate-ABS (acrylonitrile-butadiene-styrene blends). The anode chamber contains an inlet for introduction of fluids containing biodegradable materials and an outlet for the fluids. Where the microbial cell is functioning properly, the fluid exiting through the outlet has a lower concentration of biodegradable materials than the fluid fed to the anode chamber. The anode chamber may be of any shape or configuration which facilitates the contacting of the anode, the microbes and the fluid containing the biodegradable material. In a preferable embodiment the anode chamber is shaped so as to provide a housing for a bed of anode material and microbes that the fluid containing biodegradable material can flow through. The anode can be any shape which performs the function of collecting elections generated as a result of the degradation of biodegradable material. The shape can be cylindrical, tubular, rectangular box, sheet-like and the like. Sheet-like as used herein means that the cathode resembles a three dimensional sheet having relatively large dimensions in one plane and a relatively small dimension in the direction perpendicular to the plane defined by the large dimensions, which can be referred to as the thickness. The shape of the sheet-like anode in the plane of the large dimensions can be any shape that allows the anode to function as described herein. The shape of the anode in the plane of the large dimensions can be irregular, trapezoidal, circular, oval, square, rectangular and the like. The shapes do not need to be precise in that the corners of trapezoids, squares and rectangles can be rounded and the angles do not need to be precise or 90 degrees. The edges of the sheet-like anode do not need to be square or at right angles and can be curved or partially curved. Edges as used herein are the sides of the sheet-like material along the small dimension. The size of the chamber is chosen to fit the anode shape and volume and the desired capacity of the microbial fuel cell, which an engineer skilled in the art can determine. In a preferred embodiment the anode chamber or the anode has the shape sheet-like material having a rectangular shape in the plane of the two large dimensions. Preferably, the dimension of the chamber or anode in the direction of the smallest dimension, that is the thickness of the anode, is about 10 mm or less, more preferably about 5 mm or less. Preferably such dimension, thickness, is about 1 mm or greater.

The cathode is disposed to be in contact with an oxygen containing fluid (gas). The cathode can be open to an environment containing an oxygen containing gas, such as air, or it can be located in a cathode chamber. In one embodiment, the microbial fuel cell can be located in a container of fluid containing the biodegradable material, for instance the microbial cell cart be immersed in such fluid. In this embodiment the cathode is disposed in a cathode chamber. The cathode chamber functions to contain the cathode and the oxygen containing gas. The cathode chamber may be fabricated from any material that is compatible with the cathode and the oxygen containing gas. In a preferred embodiment, the cathode chamber may be fabricated from a rigid plastic material as described with respect to the anode chamber. Preferably the cathode chamber is fabricated from the same material as the anode chamber. The cathode chamber may contain an inlet for introduction of oxygen containing gas and/or an outlet for the oxygen containing gas.

Where oxygen gas is flowed through the cathode chamber, the gas exiting through the outlet has a lower concentration of oxygen than the gas fed to the cathode chamber. The cathode chamber may be of any shape or configuration which facilitates the contacting of the cathode and the oxygen containing gas. In another preferred embodiment, the cathode chamber allows for the diffusion of oxygen containing gas into and out of the cathode chamber. The shape of the cathode or the cathode chamber can be any shape which allows the cathode to function as recited herein. Preferably the shape is any of the shapes described as preferable for the anode and the anode chamber. The size of the chamber is chosen to fit the desired capacity of the microbial fuel cell, which an engineer skilled in the art can determine.

Preferably, a portion of the anode chamber is open toward the cathode. Preferably, a portion of the cathode chamber is open toward the anode. Preferably the opening of the cathode chamber and the anode chamber match one another. In one preferred embodiment, the cathode chamber and anode chamber have matching openings which are adapted to mate and form a closed chamber. In one embodiment the two chambers are open to one another. Preferably a separator is disposed on the opening of the anode chamber or cathode chamber or between the openings of the anode chamber and the cathode chamber. The separator functions to electrically insulate between the anode and the cathode and allows the flow of ions between the cathode and the anode. Preferably, the separator also prevents the flow of microbes and biodegradable material from the anode to the cathode. Preferably, the separator limits or prevents the flow of gas or liquids between the anode and the cathode chambers. Any separator that performs this function may be used in this invention. Preferred forms of separators include screens, cloth, films and membranes. Preferably, an ion exchange membrane is located on the opening of the anode chamber or cathode chamber or between the anode chamber and the cathode chamber at the opening of each. Preferably a seal is disposed about the edges of the anode chamber, the cathode chamber or the matched openings of the cathode and the anode to inhibit, control or prevent transport of fluids in or out of the anode chamber, cathode chamber or fuel cell, or between the cathode and anode chambers. In one preferred embodiment, the screen, cloth, film or membrane disposed between the cathode and anode chambers also functions as a seal about the periphery of the junction of the two chambers.

The anode is comprised of an electrically conductive material. Any material which is electrically conductive and is compatible with the microbes may be used. Compatible with the microbes means that the anode material does not kill the microbes or interfere with the microbes catalyzing the decomposition of the biodegradable material. Preferably, the electrically conductive material is an electrically conductive metal, or an electrically conductive carbon. A preferred electrically conductive metal is titanium. Any carbon which is electrically conductive may be used in this invention. Preferred classes of carbon include carbon black, graphite, graphene, graphite oxide and carbon nanotubes. Another preferred form of carbon comprises a matrix of expanded graphite having pores which pass through the carbon matrix. The electrically conductive material can be in any form which allows efficient contact between the microbes, the anode and the fluid containing biodegradable material and which forms electron flow passages to the electron conduit and through the circuit to the cathode. It is desired that the electrically conductive materials have as high a surface area as possible. The relevant surface area is the surface area available for contact with the fluid containing biodegradable material. In one embodiment the anode is a bed defined by the anode chamber filled with the electrically conductive material. The electrically conductive material can be in the form of a sheet, paper, cloth, interwoven fibers, random fibers, organized fibers, particles, beads, granules, pellets, agglomerated particles, foam, a monolith having pores communicating through the monolith, or any combination thereof. In preferred embodiment the electrically conductive materials comprise carbon cloth, carbon paper, carbon felt, carbon wool, carbon foam, graphite, porous graphite, graphite powder, graphite granules, graphite fiber, agglomerated conductive carbon black and reticulated vitreous carbon. In the embodiment wherein the electrically conductive material is in the form of particles or granules, such particles or granules are preferably of a size suitable for supporting bacteria disposed on the particles or granules. In one embodiment the electrically conductive material may be dispersed in a matrix such as a polymer compatible with the system, the matrix can be in the form of a film, bead, pellet and the like. Preferably the particle size is of a size such that the fluid containing biodegradable material can flow through the anode or anode bed without undue backpressure and such that the biodegradable material in the fluid is able to come into contact with the microbes. Preferably the particle size is about 1 micron or greater and most preferably about 10 microns or greater. Monolith as used herein refers to a unitary structure having pores located through the structure that the fluid containing biodegradable material can flow through. The pores in the anode are preferably of a size such that the fluid containing biodegradable material can flow through the anode or anode bed without undue backpressure, the microbes can reside on the surface of the pores and such that the biodegradable material in the fluid is able to come into contact with the microbes. As used herein a bed of electrically conductive material means electrically conductive material of any shape or size contained in a confined space in a manner such that the fluid containing the biodegradable material can flow through the bed and contact a significant portion of the surface area of the electrically conductive material. Preferably the bed shape is as described hereinbefore with respect to the anode and the anode chamber. Preferably the surface area of the anode is about 0.01 m²/g or greater, more preferably about 0.1 m²/g or greater and most preferably about 1.0 m² /g or greater. Organized fibers as used herein means that fibers are arranged in a designed shape such as in a brush shape as described in Logan et al US 2008/0292912, incorporated herein by reference, and the like. Typically, the anode provides a surface for attachment and growth of microbes and therefore the anode is made of material compatible with microbial growth and maintenance. Compatibility of a material with microbial growth and maintenance in a microbial fuel cell may be assessed using standard techniques such as assay with a viability marker such as Rhodamine 123, propidium iodide, and combinations of these or other bacteria viability markers.

The surface area of the anode included in embodiments of a microbial fuel cell according to the present invention is greater than about 100 m² /m³. Specific surface area is here described as the surface area of the anode per unit of anode volume. Specific surface area greater than about 100 m² /m³ contributes to power generation in microbial fuel cells according to embodiments of the present invention. In further embodiments, microbial fuel cells according to the present invention include an anode having a specific surface area greater than about 1000 m² /m³. In still further embodiments, the microbial fuel cells according to the present invention include anodes having a specific surface area greater than about 5,000 m² /m³. In yet further embodiments fuel cells according to the present invention include anodes having a specific surface area greater than about 10,000 m² /m³. An anode configured to have a high specific surface area allows for scaling of a microbial fuel cell according to the present invention.

In one preferred embodiment the anode comprises a mixture of one or more electrically conductive materials and one or more ionically conductive materials. Preferred ionically conductive materials are ion exchange materials. The mixture is arranged such that electron flow paths and ion flow paths are created through the anode. The electrically conductive materials create a flow path of electrons to the electron conduit and through a circuit to the cathode. The ionically conductive materials create a flow path of ions, preferably hydrogen ions to the cathode chamber or hydroxide ions from the cathode chamber. The respective materials need to be present in sufficient amount and in a suitable arrangement so as to form the desired flow paths. The arrangement can be akin to interpenetrating networks or one of the materials, preferably the ionically conductive materials, can be disposed in layers or continuous strips through the anode chamber wherein the layers or strips are in contact with the cathode chamber or ion exchange membrane or electron conduit. In a preferred embodiment a blend of particles of both materials is utilized such that the desired flow paths are present. Preferably, an anode of conductive material and ionically conductive material comprises about 30 volume percent or greater of electrically conductive material based on the solid material present, more preferably about 40 volume percent or greater and most preferably about 45 volume percent or greater. Preferably an anode of electrically conductive material and ionically conductive exchange material comprises about 70 volume percent or less of electrically conductive material based on the solid material present, more preferably about 60 volume percent or less and most preferably about 55 volume percent or less. Preferably an anode of electrically conductive material and ionically conductive material comprises about 30 volume percent or greater of ionically conductive material based on the solid material, more preferably about 40 volume percent or greater and most preferably about 45 volume percent or greater. Preferably, an anode of electrically conductive material and ionically conductive material comprises about 70 volume percent or less of ionically conductive material based on the solid material, more preferably about 60 volume percent or less and most preferably about 55 volume percent or less. “Based on the solid material” means that the volume of pores and spaces between particles is not included in the recited volume.

The anode comprises spaces around particles in the anode and/or pores in the material used to form the anode. The fluid containing biodegradable material flows through the anode by flowing around the particles or through the pores. The spaces between the particles and size of the pores need to be of a size such that the microbes can reside on the surface of the particles or the pores, the biodegradable material can contact the microbes and such that as the fluid flows through the anode. The spaces between the particles are best described and the percent of void space, space not occupied by solid material, preferably the void space is about 20 percent by volume or greater, more preferably about 33 volume percent or greater, more preferably about 50 volume percent by weight or greater. Preferably the void space is about 96 percent by weight or less. The corollary is that the solid volume is about 80 volume percent or less, more preferably about 67 volume percent or less and more preferably about 50 volume percent or less. Preferably the solid volume is about 4 volume percent or greater. The median spaces or pore size are preferably about 5 microns or greater and more preferably about 10 microns or greater. The median spaces or pore size are preferably about 1000 microns or less and more preferably about 100 microns or less. In another embodiment, the anode and/or the cathode chambers have inlets and or outlets to facilitate flow through the cathode and or anode chambers.

The microbial fuel cells of the invention preferably comprise a means for introducing fluid material to the anode wherein the fluid flows through the anode in a direction substantially parallel to one of the faces of the ion exchange membrane. Such means can be any means which introduces a fluid to the anode in the designated flow path. In one preferred embodiment such means includes one or more of an inlet and an outlet arranged such the flow of fluid through the anode is substantially parallel to one face of the separator. In another embodiment a means of creating flow of the fluid such as a blower or impeller and the like are utilized to force fluid in the desired direction with respect to the anode. Substantially parallel means that the flow of fluid is generally parallel to the separator but the angle of the vector of flow is not precise. Where the anode is in a sheet-like shape the flow of fluid is preferably perpendicular to the thickness dimension of the anode. Preferably, the flow of fluid through the anode is perpendicular to the thickness dimension of the anode and substantially parallel to one face of the separator.

The cathode comprises an electrically conductive material which is capable of transmitting electrons. The electrically conductive material can be any electrically conductive material described as useful for the anode. In a preferred embodiment the cathode further comprises a catalyst for the oxidation reduction reactions. Preferred classes of catalysts are Group VIII metals and oxidase enzymes. Preferred metals are the noble metals, with platinum and palladium more preferred. The catalyst can be located on the cathode or where the cathode is disposed in a chamber it may be in any location in the cathode chamber. Preferably, the catalyst is located on the surface of the cathode. In the embodiment wherein the catalyst is a metal, the catalyst concentration is chosen such that the oxidation reduction reaction in the cathode chamber proceeds at a reasonable rate. Preferably the catalyst is present in an amount of about 0.10 mg of metal per square centimeter of projected cathode surface area or less, more preferably about 0.05 mg of metal per square centimeter of projected cathode surface area or less and most preferably about 0.02 mg of metal per square centimeter of projected cathode surface area or less. Preferably the catalyst is present in an amount of about 0.001 mg of metal per square centimeter of projected cathode surface area or greater, more preferably about 0.005 mg of metal per square centimeter of projected cathode surface area or greater, even more preferably about 0.01 mg of metal per square centimeter of projected cathode surface area or greater and most preferably about 0.015 mg of metal per square centimeter of projected cathode surface area or greater. The cathode is preferably a solid material with a large surface area.

The anode chamber and/or the cathode chamber may have a separator, barrier, located on the opening thereof. Where both the cathode and the anode are located in chambers they that may have a separator, barrier, located therebetween. The separator functions to separate the anode from the cathode. The separator preferably is nonconductive, that is does not allow electrons to pass through the separator. The separator preferably allows ions to pass through the separator. Preferably the separator inhibits the flow of fluids, such as water and oxygen containing gases, therethrough. The separator preferably functions to prevent solids from flowing out of or between the chambers. The separator preferably allows ions to pass between the chambers so as to balance the pH in the two chambers. The separator can be a cloth, screen, film or an ion exchange membrane. In a preferred embodiment the ion exchange membrane is an anion exchange membrane. The ion exchange membrane can be heterogeneous, homogeneous, supported or unsupported. The ion exchange membrane needs to be biocompatible, that is not harm the biological materials in the system. In one preferred embodiment the ion exchange membrane is a film prepared from a blend of ion exchange resins and a binder. The ion exchange resins may be subjected to an operation to reduce the particle size prior to contacting with the binder. The anion exchange membranes can contain any cationic moiety which facilitates the transfer of anions from the cathode to the anode. Preferred cationic moieties in the anionic exchange membrane are nitrogen containing cationic groups and preferably cationic ammonium ions, quaternary ammonium ions, imidazolium ions, pyridinium ions, and the like. The membrane allows transport of a desired material through the membrane. In preferred embodiments, the membrane prevents microbes of a size of about 1000 nanometers from passing through the membrane. Thus, the flow of water and/or microbes through the membrane and any included membrane coatings is restricted. Microfiltration, nanofiltration and ion exchange membrane compositions are known in the art and any of various membranes may be used which exclude microbes and allow diffusion of a desired fluid (gas) through the membrane. Illustrative examples of microfiltration, nanofiltration and/or ion exchange membrane compositions include, but are not limited to, halogenated compounds such as tetrafluoroethylene, tetraflouroethylene copolymers, tetrafluoroethylene-perfluoroalkylvinylether copolymers, polyvinylidene fluoride, polyvinylidene fluoride copolymers, polyvinyl chloride, polyvinyl chloride copolymers; polyolefins such as polyethylene, polypropylene and polybutene; polyamides such as nylons; sulfones such as polysulfones and polyether sulfones; nitrile-based polymers such as acrylonitriles; and styrene-based polymers such as polystyrenes. Examples of suitable membrane materials are ultrafiltration and nanofiltration membranes commonly employed in the water treatment industry to filter water while excluding bacteria. For example, a suitable membrane is ultrafiltration membrane B 0125 made by X-Flow, The Netherlands. Additional examples include CMI and AMI ion exchange membranes made by Membranes International, Inc. New Jersey, USA.

The separator is preferably a sheet having two opposing faces. In one preferred embodiment, the cathode is disposed adjacent to the separator. More preferably, the cathode is located adjacent to and in contact with one face of the separator. In one embodiment, the cathode is coated onto or printed on one face of the separator. In another embodiment the anode is located adjacent to the separator. More preferably the anode is located adjacent to and in contact with one face of the separator. Preferably the anode and the cathode are each adjacent to and in contact with opposing faces of the separator.

In the vicinity of the anode, located in the anode chamber where one is used, are microbes which are electrogenic, that is produce electrons when degrading biodegradable materials. The microbes are preferably found on the surface of the anode. Preferably they colonize on and live on the surface of the anode. Microbes as used herein include bacteria, archaea, fungi and yeast. Preferred microbes are anodophilic bacteria. The terms “anodaphiles” and “anodophilic bacteria” as used herein refer to bacteria that transfer electrons to an electrode, either directly or by endogenously produced mediators. Often, anodophiles are obligate or facultative anaerobes. The term “exoelectrogens” is also used to describe suitable bacteria. Examples of anodophilic bacteria include bacteria selected from the families Aeromonadaceae, Alteromonadaceae, Clostridiaceae, Comamonadaceae, Desulfuroromonaceae, Enterobacteriaceae, Geobacteraceae, Pasturellaceae, and Pseudoraonadaceae. These and other examples of bacteria suitable for use in an inventive system are described in Bond, D. R., et al, Science 295, 483-485, 2002; Bond, D. R. et al., Appl. Environ. Microbiol. 69, 1548-1555, 2003; Rabaey, K., et al., Biotechnol Lett. 25, 1531-1535, 2003; U.S. Pat. No. 5,976,719; Kim, H. J., et al., Enzyme Microbiol. Tech. 30, 145-152, 2002; Park, H. S., et al., Anaerobe 7, 297-306, 2001; Chauduri, S. K., et al., Nat. Biotechnol., 21:1229-1232, 2003; Park, D. H. et al., Appl. Microbiol. Biotechnol, 59:58-61, 2002; Kim, N. et al., Biotechnol. Bioeng., 70:109-114, 2000; Park, D. H. et al., Appl. Environ. Microbiol., 66, 1292-1297, 2000; Pham, C. A. et al., Enzyme Microbiol. Technol., 30: 145-152, 2003; and Logan, B. E., et al., Trends Microbiol. 14(12):512-518, all incorporated herein by reference. Anodophilic bacteria preferably are in contact with an anode for direct transfer of electrons to the anode. However, in the case of anodophilic bacteria which transfer electrons through a mediator, the bacteria may be present elsewhere in the reactor and still function to produce electrons useful in an inventive process. Anodophilic bacteria may be presided as a purified culture, enriched in anodophilic bacteria, or even enriched in a specified species of bacteria, if desired. Pure culture tests have reported Coulombic efficiencies as high as 98.6% in Bond, D. R. et al., Appl. Environ. Microbiol 69, 1548-1555, 2003, incorporated herein by reference. Thus, the use of selected strains may increase overall electron recovery and hydrogen production, especially where such systems can be used under sterile conditions. Bacteria can be selected or genetically engineered that can increase Coulombic efficiencies and potentials generated at the anode. Further, a mixed population of microbes may be utilized, including anodophilic anaerobes and other bacteria.

The feed to the microbial cell comprises a biodegradable material in a fluid. A biodegradable material included in a microbial fuel cell according to embodiments of the present invention is oxidizable by anodophilic bacteria or biodegradable to produce a material oxidizable by anodophilic bacteria. The term “biodegradable” as used herein refers to an organic material decomposed by biological mechanisms illustratively including microbial action, heat and dissolution. Microbial action includes hydrolysis, for example. The fluid is preferably a liquid, more preferably water or an organic liquid, with water more preferred. Any of various types of biodegradable organic matter may be used as “fuel” for microbes in amicrobial fuel cell, including fatty acids, sugars, alcohols, carbohydrates, amino acids, fats, lipids and proteins, as well as animal, human, municipal, agricultural and industrial wastewaters. Naturally occurring and/or synthetic polymers illustratively including carbohydrates such as chitin and cellulose, and biodegradable plastics such as biodegradable aliphatic polyesters, biodegradable aliphatic-aromatic polyesters, biodegradable polyurethanes and biodegradable polyvinyl alcohols. Specific examples of biodegradable plastics include polyhydroxyalkanoates, polyhydioxybutyrate, polyhydroxyhexanoate, polyhydroxyvalerate, polyglycolic acid, polylactic acid, polycaprolactone, polybutylene succinate, polybutylene succinate adipate, polyethylene succinate, aliphatic-aromatic copolyesters, polyethylene terephthalate, polybutylene adipate/terephthalate and polymethylene adipate/terephthalate. Organic material oxidizable by anodophilic bacteria are known in the art. Illustrative examples of an organic material oxidizable by anodophilic bacteria include, but are not limited to, monosaccharides, disaccharides, amino acids, straight chain or branched C₁-C₇ compounds including, but not limited to, alcohols and volatile fatty acids. In addition, organic material oxidizable by anodophilic bacteria include aromatic compounds such as toluene, phenol, cresol, benzoic acid, benzyl alcohol and benzaldehyde. Further organic material oxidizable by anodophilic bacteria are described in Lovely, D. R. et al., Applied and Environmental Microbiology 56:1858-1864, 1990, incorporated herein by reference. In addition, a provided material may be provided in a form which is oxidizable by anodophilic bacteria or biodegradable to produce an organic material oxidizable by anodophilic bacteria. Specific examples of organic material oxidizable by anodophilic bacteria include glycerol, glucose, acetate, butyrate, ethanol, cysteine and combinations of any of these or other oxidizable organic substances.

In a preferred embodiment, the biodegradable material in a fluid is a waste stream containing biodegradabale material. The fluid for the waste stream can be organic or aqueous. The waste stream can be a waste stream from a chemical or biological process or a waste water stream. The waste water stream can come from a chemical or biological process, a municipal waste water stream or a contaminated water source.

An electron transfer mediator which functions to enhance the transfer of electrons to the anode may be located in the vicinity of the anode, for instance in the anode chamber. Any compound known in the art to perform this function may be utilized in the microbial fuel cells of this invention. Preferred mediators are exemplified by ferric oxides, neutral red, anthraquinone-1,6-disulfonic acid (ADQS) and 1,4-napthoquinone (NQ). Examples of other known mediators include phenazine methosulfate, 2,6-dichlorophenol indophenol, thionine, toluidine, potassium ferricyanate and 1,4-naphthoquinone. Mediators are optionally chemically bound to the anode, or the anode modified by various treatments, such as coating, to contain one or more mediators.

The biodegradeable material in the fluid in many known microbial fuel, cell processes exhibit low conductivity. The low conductivity inhibits the flow of ions between the anode and the cathode. To address this problem many known processes add buffers to the fluid containing the biodegradable material. Common buffers contain phosphates. In embodiments wherein the effluent from the microbial cells is a purified waste stream, the presence of phosphates or certain other buffers is undesirable. In one embodiment of the invention a buffer which is environmentally friendly may be added, for instance a carbonate or source of carbonate such as carbon dioxide. In a more preferred embodiment, enabled by the combination of the anion exchange membrane and the oxygen-reducing cathode, the microbial fuel cell is operated using an unbuffered feed. The unbuffered waste water can be directly fed to the microbial fuel cell or, optionally, electrolytes can be added. Preferably, the conductivity of the feed is 10 millisiemiens/cm or less, more preferably 5 millisiemens/cm or less and most preferably 2 millisiemens/cm or less. Preferably, the conductivity of the feed is 0.5 millisiemins/cm or greater and more preferably 0,9 millisiemens/cm or greater.

The cathode is contacted with an oxygen containing gas. Oxygen is reduced in vicinity of the cathode to form water or hydroxide ions, such as in a cathode chamber. Any gas containing oxygen may be contacted with the cathode. Air is preferred for cost reasons. Pure oxygen or an oxygen enriched stream may be used. In a preferred embodiment, a flow of oxygen containing gas to the cathode may be utilized. In such embodiment, a blower may be used to contact the oxygen containing gas with the cathode.

An electron conduit connects the anode and the cathode and functions to flow electrons between the anode and cathode through an external circuit. The electron conduit can be any material or shape which performs the recited function. Preferably the electron conduit is comprised of an electrically conductive metal, preferable electrically conductive metals include copper, silver, gold or iron or alloys containing such metals, with copper or steel being most preferred. Preferably, the electron conduit is in a wire or sheet form, and most preferably a wire form. Preferably, the conduits connect the cell to an electrical load. Load used herein means a device or element that consumes the electrical energy from the microbial fuel cell. The load can be a resistor, where the electrical energy from the microbial fuel cell is converted into thermal energy (heat); the load can be a motor, where the electrical energy from the microbial fuel cell is converted into mechanical energy (work); the load can be isolated from the microbial fuel cell by on one or more electronic circuits such as a voltage inverter, a power grid, etc. In one preferred embodiment the load is an electrical device which a portion of the current generated can power. In another embodiment the load can be a battery adapted to store the generated electricity or a power grid to distribute the electricity for use.

The microbial fuel cells of the invention may further comprise one or more current collectors, which form part of the electron conduit. The current collector may be the electron conduit or may be one part of the electron conductor, A current collector functions to collect current from an electrode (cathode or anode) and deliver it to the electrical circuit. Preferred current collectors comprise a conductive metal. The current collector is preferably adjacent to and in intimate contact with an electrode, Current collectors may be of any shape that allows them to be adjacent to or in contact with an electrode. Preferably the current collector is a wire, screen or sheet of metal shaped to contact a significant portion of an electrode.

One or more regulator devices, such as one or more valves, may be included to further regulate flow of materials into and out of an anode or cathode chamber. Further, one or more caps or seals may be optionally used to close a channel used to introduce a fluid into an anode chamber or a cathode chamber. For example, where a fuel cell is operated remotely or as a single use device such that no additional materials are added, a cap or seal is optionally used to close a channel. A pump may be provided for enhancing flow of liquid or gas into and/or out of a reaction chamber,

The microbial fuel cells of the invention may be assembled by placing the anode, and optionally the electron mediators, in contact with a separator or in an anode chamber. The cathode, and optionally the current collector, is placed in contact with a separator or in a cathode chamber. A seal and/or a separator (barrier material) is placed about or on the opening of an anode or cathode chamber. Where both the anode and cathode are placed in chambers, the cathode chamber and the anode chamber are brought into contact along their respective mating surfaces with the seal and/or the separator, barrier material, such as an anion exchange membrane, located therebetween. The anode and cathode chambers are held in place by any known means, such as through the use of mechanical fasteners or adhesives. Mechanical fasteners, such as screws, are preferred to facilitate disassembly of the microbial fuel cell to repair or clean the cell. Inlet and outlet fluid conduits may be attached to the anode and cathode inlets and outlets. Such conduits ate further connected to sources of feed material for the anode chamber, biodegradable material in a fluid, and for the cathode chamber, oxygen containing gas. If desired, the cell through the electron conduit may be connected to a load. Initially the anode chamber needs to be innoculated with the bacteria. This is performed by adding the microbes or a medium containing the microbes to the anode, such as to the anode chamber, and exposing the anode to conditions such that a healthy colony of the microbes is resident in on or near the anode. The details of this process are well known to the skilled artisan. Once the innoculation is complete the microbial fuel cell can be operated to produce electricity and to remove biodegradable material from a fluid stream.

One or more fuel cells can be used to generate electricity and/or reduce the amount of biodegradable material in a fluid. In operation a fluid containing biodegradable material is contacted with the anode while the cathode is exposed to an oxygen containing gas. The oxygen containing gas can be introduced into the cathode chamber by opening the chamber to the environment. Alternatively, air or an oxygen enriched, higher oxygen content, gas can be flowed into contact with the cathode, such as by blowing an oxygen containing gas over or toward the cathode. In one embodiment, the fluid containing biodegradable material is introduced into the anode chamber and the fluid having a lower biodegradable material content is the effluent from the anode chamber. The current drawn from the microbial fuel cell is chosen to either maximize the electrical power generated by the microbial fuel cell or to maximize the degradation of the biodegradable material. If the objective is to maximize the electrical power generated by the cell the current draw from the cell is such that the cell operating voltage is preferably about 0.2 volts or greater and preferably about 0.4 volts or less. If the objective is to maximize degradation of biodegradable material, the current drawn from the microbial fuel cell is such that the cell operating voltage is preferably about 0,001 volts, more preferably 0.05 volts or greater, and about 0.2 volts or less. The cell operating voltage is the voltage produced by an individual cell under operating conditions. If a plurality of cells are connected in electrical series to form a stack, then the cell operating voltage is taken to mean to average cell operating voltage of the plurality of cells comprising the stack. The electron conduit may be connected to a load so as to transfer the current to the load such as a battery, a device to be powered or to a power grid. Two or more microbial fuel cells according to the invention may be hydraulically connected in a series fashion such that the effluent from the anode chamber may be flowed into the anode inlet for another chamber. The cells may be connected in parallel arrangement or in a combination of both series and parallel fashion. The effluent from the cathode chamber may be flowed into the inlet for the cathode chamber of another cell. Where a number of cells are connected in series additional oxygen containing gas may need to be introduced in one or more downstream modules to keep the oxygen content of the oxygen containing gas at a level such that the cells operate efficiently. A number of microbial cells may be connected to the same load so as to provide the current the load needs to function.

In the embodiment wherein the biodegradable fluid is a waste stream, the waste stream may be passed through a number of microbial fuel cells until a sufficient amount of the biodegradable material in the waste stream has been removed to achieve a desired specified level of biodegradable material. Alternatively the effluent from the anode chamber can be recycled through the same cell, or same series of cells, until the desired specified level of biodegradable material is removed. In waste stream processing, a level of biodegradable material in the effluent is typically specified. The specified level of biodegradable material can be defined by a number of known measures, including chemical oxygen demand and biological oxygen demand. Once the desired level of biodegradable material is reached the fluid can be discharged, recycled for use in a process or subjected to other treatment.

An aqueous medium in a reaction chamber of a microbial fuel cell is formulated to be non-toxic to microbes in contact with the aqueous medium in the fuel cell. Further, the medium or solvent may be adjusted to be compatible with microbial metabolism, for instance by adjusting the pH to be in the range of from about 4 to about 10, preferably about 6 to about 9, inclusive, by adjusting the pH with an acid or base, adding a buffer to the medium or solvent if necessary, by adjusting the osmolarity of the medium or solvent by dilution or addition of an osmotically active substance, or any combination thereof. Ionic strength may be adjusted by dilution or addition of a salt for instance. Further, nutrients, cofactors, vitamins and other such additives may be included to maintain a healthy bacterial population, if desired, see for example examples of such additives described in Lovley and Phillips, Appl. Environ. Microbiol. 54(6): 1472-1480, incorporated herein by reference. Optionally, an aqueous medium in contact with microbes contains a dissolved biodegradable material oxidizable by the microbes. In operation, reaction conditions include variable such as pH, temperature, osmolarity, and ionic strength of the medium in the reactor. Reaction temperatures are typically in the range of about 10-40° C. for non-thermophilicmicrobes, although the device may be used at any temperature in the range of 0 to 100° C. by including suitable microbes for growing at selected temperatures. However, maintaining a reaction temperature above ambient temperature may require energy input and it is preferred to maintain the reactor temperature at about 15 to about 30° C. without input of energy.

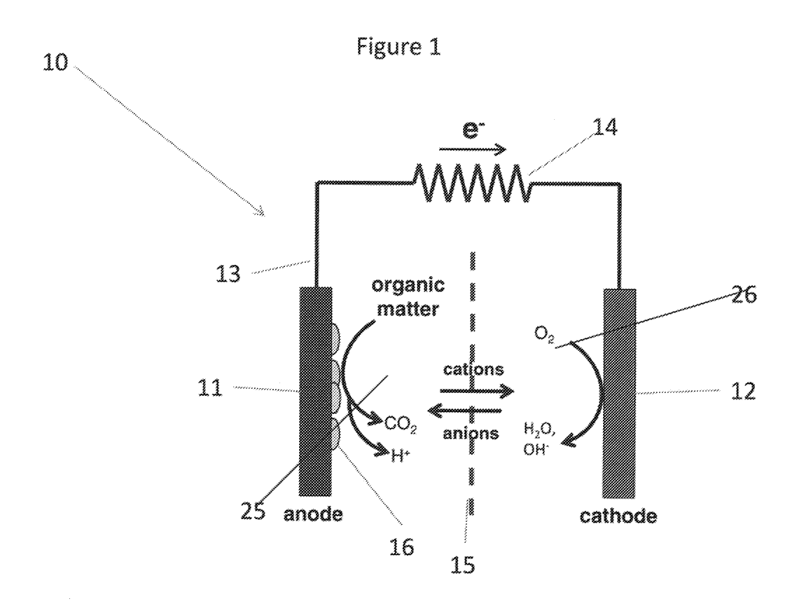

FIG. 1 shows a schematic of a microbial fuel cell 10 of the invention. The figure shows an anode 11 with microbes 16 disposed on the anode 11. Also shown is a cathode 12 wherein the anode 11 and cathode 12 are separated by a separator 15. Connected to the anode 11 and the cathode 12 is an electron conduit 13 with a load 14 located between the anode 11 and cathode 12. The figure shows cations being transported from the anode chamber 25 to the cathode chamber 26 and anions transported from the cathode chamber 26 to the anode chamber 25. The figure also shows that organic matter is decomposed to carbon dioxide and hydrogen ions in the anode chamber 25 and to water and hydroxide ions in the cathode chamber 26.

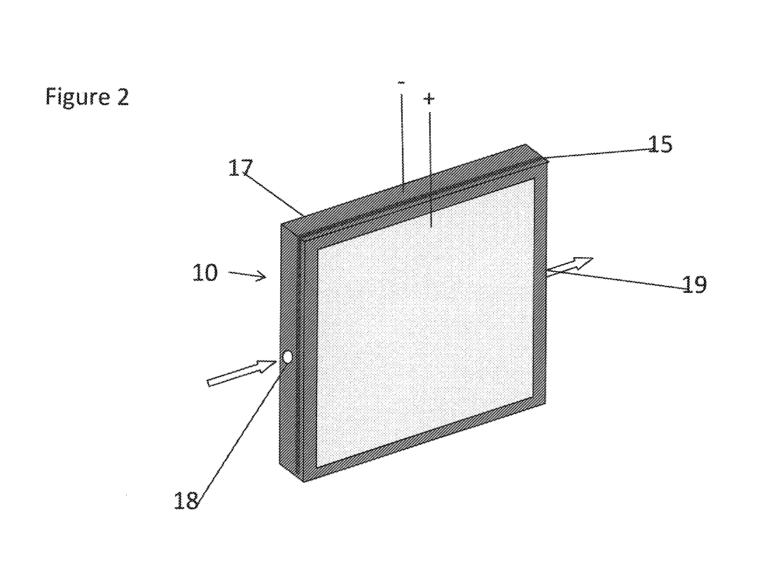

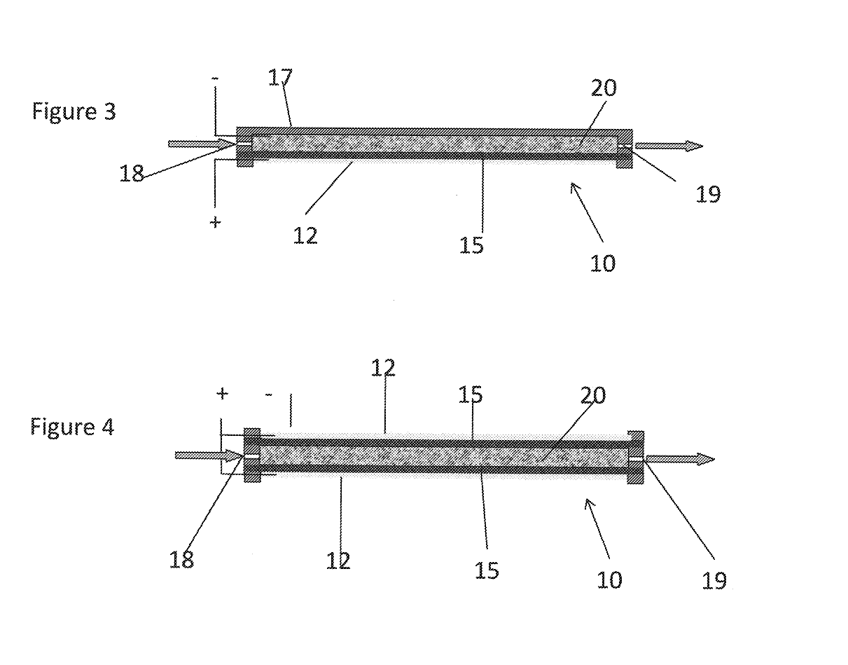

FIG. 2 shows the exterior of a microbial fuel cell 10. Shown are the housing 17, the separator 15, the fluid containing biodegradable material outlet 19 and the fluid containing biodegradable material inlet 18. FIG. 3 shows a simple microbial fuel cell of the invention 10 having a housing 17 anode bed 20, a cathode 12 and a separator 15. The anode bed 20 and the cathode 12 are disposed on opposing faces of the separator 15. Also shown are the biodegradable material containing fluid inlet 18 and the biodegradable material containing fluid outlet 19. The flow of biodegradable material containing fluid is shown as being parallel to the plane of the separator 15. The cathode 12 is open to air. The anode bed 20 functions as an anode chamber.

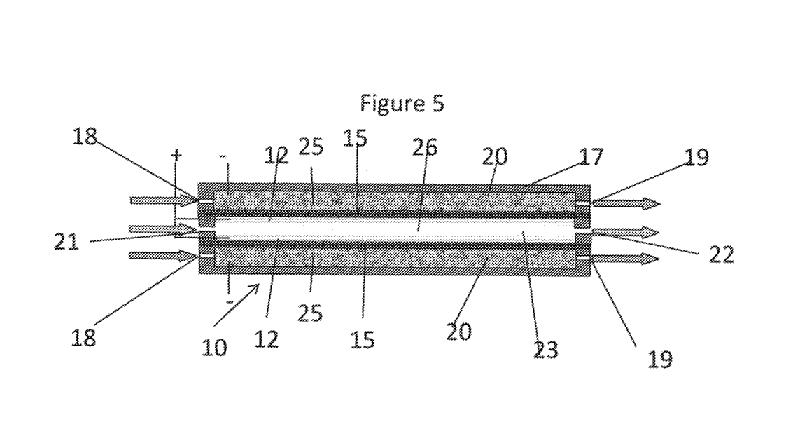

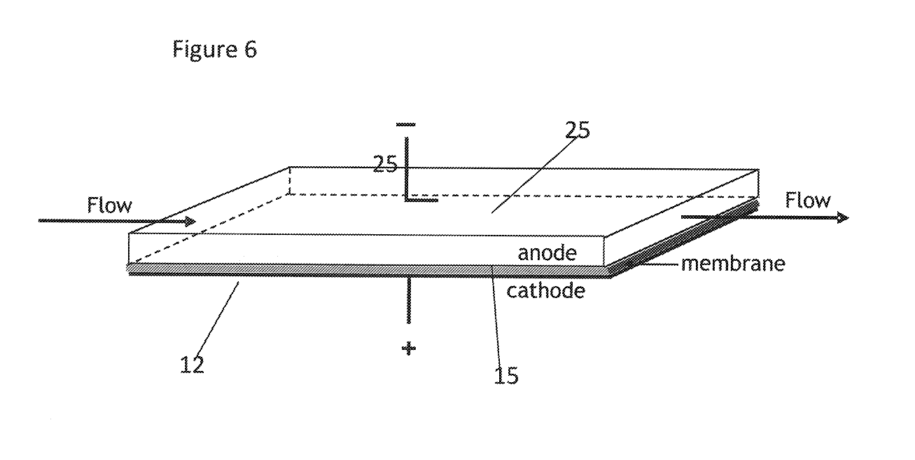

FIG. 4 shows another embodiment of an microbial fuel cell 10 which contains two cathodes 12 each disposed on one face of two separators 15 wherein each separator 15 is in contact with the one anode bed 20. Shown are the biodegradable material containing fluid inlet 18 and the biodegradable material containing fluid outlet 19. The flow of biodegradable material containing fluid is shown as being parallel to the plane of the separators 15. The cathodes 12 are open to the air. FIG. 5 shows another embodiment of an microbial fuel cell 10 which contains two cathodes 12 each disposed on one face of two separators 15 wherein each separator 15 is in contact with one of two anode beds 20. The cathodes 12 are disposed inside of the separators 15 and form a cathode chamber 26. At each end of the cathode chamber 26 are an air inlet 21 and an air outlet 22, respectively. Show are the biodegradable material containing fluid inlets 18 and the biodegradable material containing fluid outlets 19 for each anode chamber 25. The flow of biodegradable material containing fluid is shown as being parallel to the plane of the separators 15. FIG. 6 shows a 3 dimensional illustration of a sheet-like anode chamber. Also shown is a cathode 12 and a separator 15 wherein the cathode 12 and the anode chamber 25 are disposed on opposing faces of the separator.

The preferred embodiment of the present invention has been disclosed. A person of ordinary skill in the an would realize however, that certain modifications would come within the teachings of this invention. Therefore, the following claims should be studied to determine the true scope and content of the invention. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Parts by weight as used herein refers to compositions containing 100 parts by weight. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

### SPECIFIC EMBODIMENTS OF INVENTION

The following examples are included for illustrative purposes only and are not intended to limit the scope of the invention. Unless otherwise stated, all parts and percentages are by weight.

Assembly of Microbial Fuel Cell

A chamber 1.5 cm wide, about 4 cm long and 0.45 cm deep is machined in a 3 cm×6 cm×0.9 cm piece Lucite. Ports are drilled into the piece to serve as inlet and outlet ports for solution flow. Two small holes are drilled in the bottom of the chamber for wire leads. One longer wire is used as the electron conduit and another shorter wire is used as an unloaded voltage probe. The lead wires are sealed into place using epoxy. A piece of carbon felt 1.5 cm×3.0 cm×0.45 cm is placed in the chamber. An anion exchange membrane, a film prepared from a polyolefin binder and ground anion exchange resin is placed over the felt, then a cathode consisting of Pt/C on carbon paper support is cut to 1.5 cm×3 cm and placed on the membrane opposite the carbon felt anode. The cathode is then covered with a Ni screen as the current collector (with holes to accommodate the cell bolts). A second half-cell piece is then used to bolt the assembly together. Air diffuses through the inlet and outlet holes of the second half-ceil piece to the cathode.

Operation of the Microbial Fuel Cell

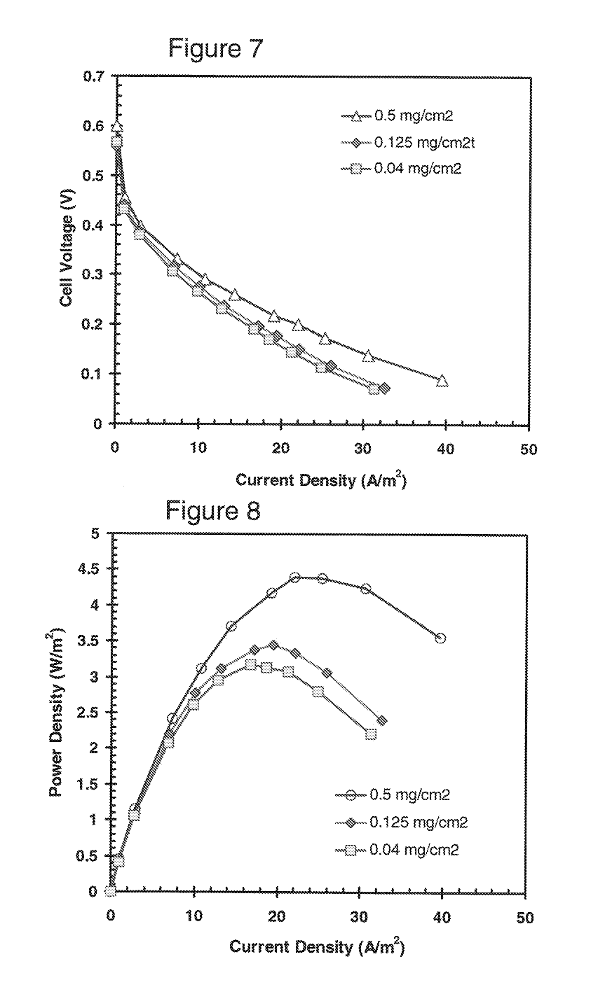

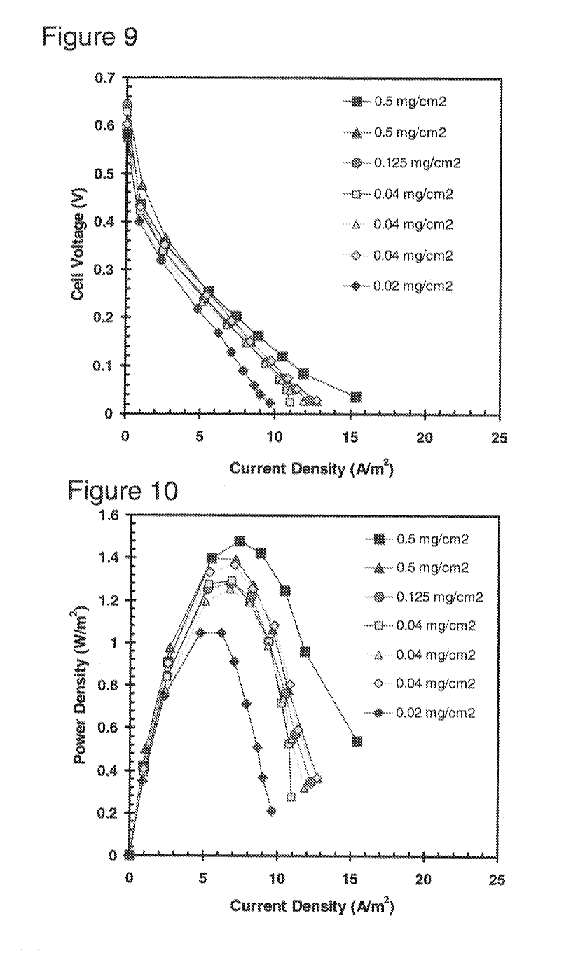

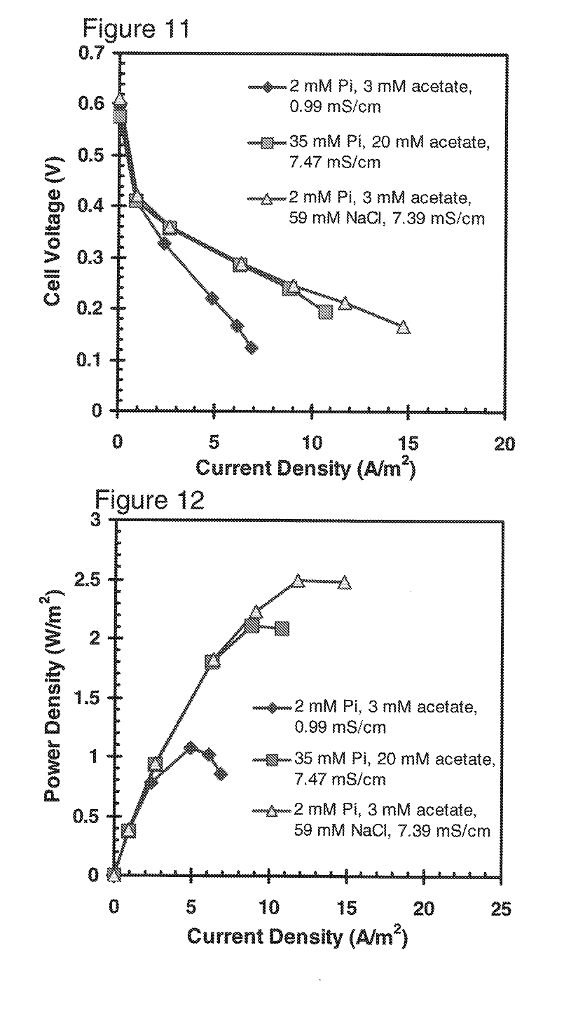

The cell is placed into a flow system that recirculates a feed solution from a reservoir through the cell. A buffered acetate feed solution is inoculated (original cells inoculated with soil extract from the back yard of a home or derived therefrom). Tests are made with a number of similar cells. In one test, different cathodes having different platinum (Pt) loadings are tested in the same cell by exchanging cathodes. In a first set of tests, the feed contains 55 mM of a phosphate buffer and 30 mM of acetate as the biodegradable material and the conductivity of the feed solution is 12.4 millisiemens per centimeter. The catalyst loadings tested are 0.5 mg/cm² , 0.125 mg/cm² and 0.04 mg/cm². FIG. 7 is the plot of the cell voltage, V, against current density A/m² of these systems at the recited catalyst loadings. FIG. 8 is the plot of power density, W/m² versus current density, A/m² of these systems at the recited catalyst loadings. In another set of tests, the feed contains 10 mM of a phosphate buffer and 6.6 mM of acetate as the biodegradable material and the conductivity of the feed solution is 2.3 millisiemens per centimeter. The platinum catalyst loading levels tested are 0.5 mg/cm² , 0.125 mg/cm² , 0.04 mg/cm² and 0.02 mg/cm². FIG. 9 is the plot of the cell voltage, V, against current density A/m² of these systems at the recited catalyst loadings. FIG. 10 is the plot of power density, W/m² versus current density, A/m² of these systems at the recited catalyst loadings. In another test, the effect of solution conductivity and buffering capacity on cell performance are examined. Three sets of systems are tested. In one system the phosphate buffer (abbreviated Pi), is present in 2 mM, the biodegradable material is 3 mM acetate and the conductivity is 0.99 millisiemens per centimeter. In a second, the phosphate buffer, Pi, is present in 50 mM, the biodegradable material is 20 mM acetate and the conductivity is 7.47 millisiemens per centimeter. In a third, the phosphate buffer, Pi, is present in 2 mM, the biodegradable material is 3 mM acetate and 59 mM sodium chloride is present as a (non-buffering) electrolyte and the conductivity is 7.39 millisiemens per centimeter. FIG. 11 shows a plot of the cell voltage, V, against current density A/m² of these systems. FIG. 12 is the plot of power density, W/m² versus current density, A/m² of these systems. There is data showing that the solution pH does not change appreciably with time during operation. There is data showing that a MFC with 0.5 mg/cm² Pt is capable of treating municipal waste water.

Composite Anode Preparation 1, Anode 1

Graphite felt is washed with deionized (DI) water. Expanded graphite worms (Superior Graphite) are washed with DI water. Dow MARATHON™ 11 anion exchange beads are washed with DI water. Ground beads are prepared by grinding Dow MARATHON™ 11 anion exchange heads in a small coffee grinder followed by washing with DI water. Equal parts of moist expanded graphite and anion exchange beads are mixed with a spatula into a uniform paste. The anode chamber is filled with a portion of this paste.

Expanded Graphite Anode Preparation 1, Anode 1

The anode chamber is filled with one anode chamber volume of moist expanded graphite.

Composite Anode Preparation 2, Anode 3

Equal volumes of moist expanded graphite and anion exchange beads ate mixed with a spatula into a uniform paste. The anode chamber is filled with a portion of this paste.

Graphite Felt Anode Preparation, Anode 4 and 5

A 1.5 cm×3 cm×0.5 cm piece of graphite felt is placed into the anode chamber.

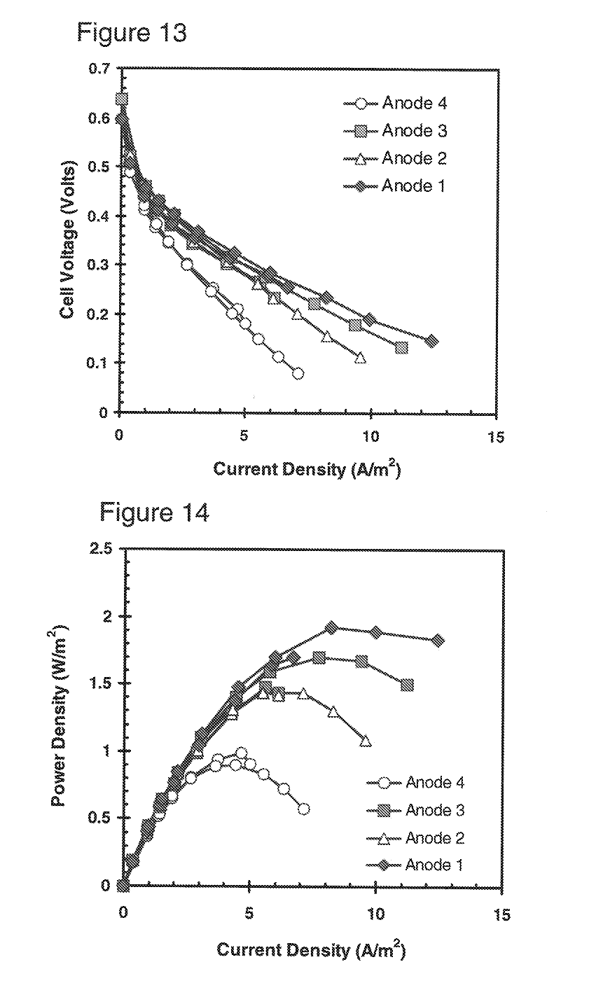

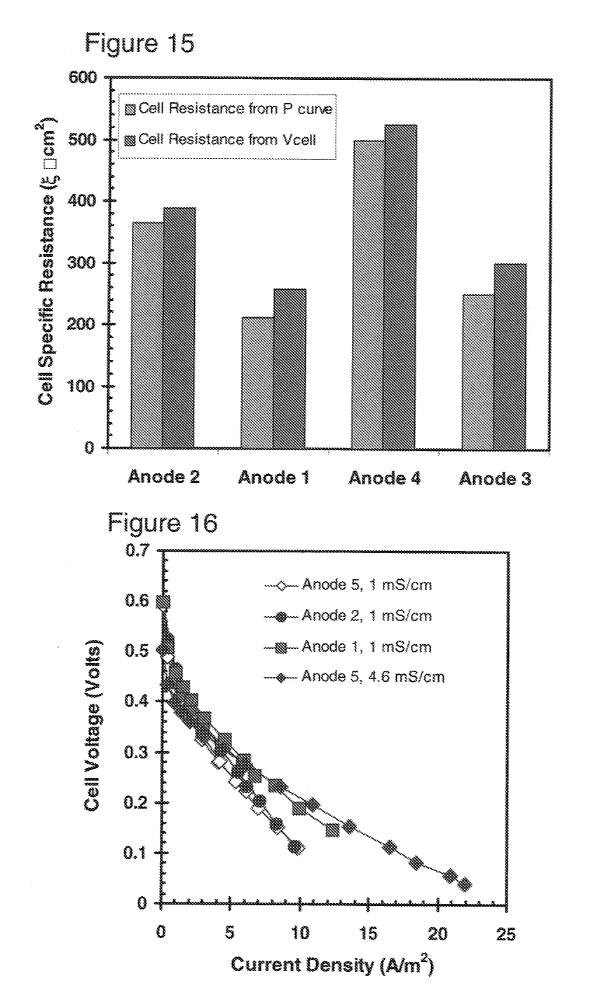

Cells assembled as described above using the anodes described above are placed into a flow system that recirculated a feed solution of 5 mM acetate, 5 mM bicarbonate, 1 mM NH₄Cl, pH=8.9, conductivity=1 mS/cm from a reservoir through the cell. The cell with anode 1 and the anode 2 are connected hydraulically in series (i.e. the effluent from the first is the influent to the second) and the cell with anode 3 and anode 4 are connected hydraulically in series. The anolyte solution is also recirculated through a well developed microbial fuel cell having a third graphite anode, anode 5, connected in parallel to the two pairs of cells. Over a period of 5 days, the current drawn from the cells is steadily increased as the cells are started up. On Day 7, cell voltage and current data for the cells is collected. FIG. 13 shows a plot of the cell voltage versus the current density for cells with Anodes 1 to 4. FIG. 14 shows the plot of cell voltage to current density for anodes 1 to 4. FIG. 5 is a bar graph of the cell resistance from P curve and the cell resistance from V cell for anodes 1 to 4.

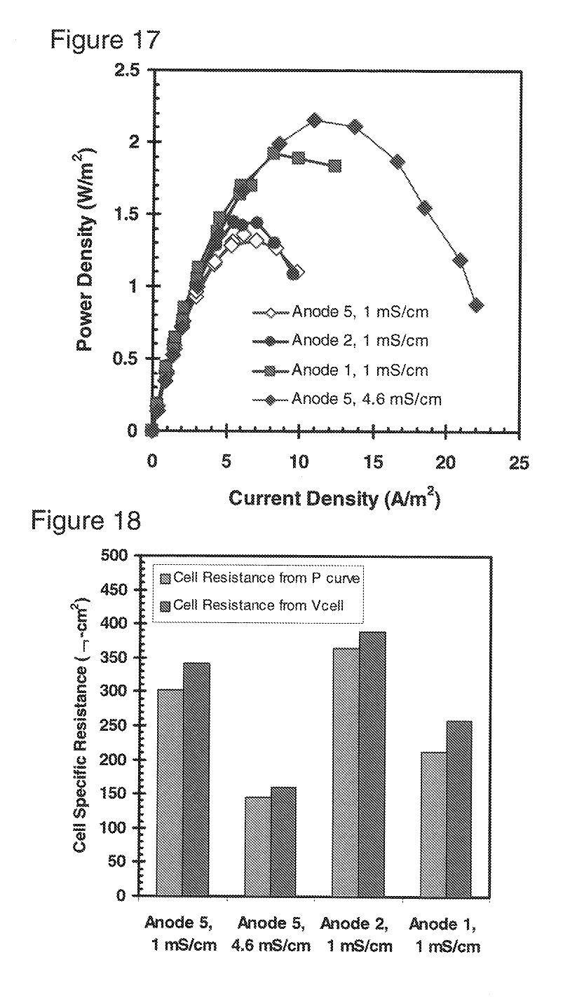

The cell with anode 5 is operated on a feed solution of 10 mM acetate, 10 mM bicarbonate, 10 mM NaCl, 10 mM KCl, 1 mM NH4Cl, pH=8.9, conductivity=4.6 mS/cm FIG. 16 shows a plot of the cell voltage versus the current density for cells with Anodes 1, 2 and 5 at conductivity of 1 mS/cm and of 4.6 mS/cm. FIG. 17 shows the plot of power density versus current density for Anodes 1, 2 and 5. FIG. 18 is a bar graph of the cell resistance from P curve and the cell resistance from V cell for Anodes 1, 2 and 5.

1. A microbial fuel cell comprising:
A) an anode containing one or more electrically conductive materials which is arranged to provide flow paths for electrons through the electrically conductive material and to form flow paths for fluid material through passages formed in the electrically conductive material;
B) electrogenic microbes in electrical contact with the anode;
C) a cathode containing one or more electrically conductive materials adapted such that the cathode can be contacted with oxygen containing fluid;
D) an anion exchange membrane disposed between the anode and the cathode;
E) a conduit for electrons which forms a circuit in contact with both the anode and the cathode; and,
F) a means for introducing fluid material to the anode wherein the fluid flows through the anode in a direction substantially parallel to one of the faces of the anion exchange membrane.

2. A microbial fuel cell according to claim 1 wherein one or both of the anode and the cathode are located in a sealed chamber.

3. A microbial fuel cell according to claim 2 wherein the anode is in an anode chamber wherein the chamber has an inlet adapted to introduce a fluid containing biodegradable material and an outlet for removing fluid from the chamber.

4. A microbial fuel cell according to claim 2 wherein the cathode chamber is adapted to introduce an oxygen containing gas into the chamber so as to place the oxygen containing gas in contact with the cathode.

5. A microbial fuel cell according to claim 1 adapted to be placed in a container of fluid containing biodegradable material.

6. A microbial fuel cell according to claim 1 wherein the cathode is open to the air.

7. A microbial fuel according claim 1 wherein the cathode further contains a catalyst for the reduction of oxygen.

8. A microbial fuel cell according to claim 1 wherein the anode and cathode are disposed adjacent to the anion exchange membrane.

9. A microbial fuel cell according to claim 1 wherein the membrane has two faces and the cathode is supported on one face of the membrane wherein the face of the membrane that the cathode is supported on is in contact with an oxygen containing gas.

10. A microbial fuel cell according to claim 1 further comprising a load connected to the circuit.

11. A microbial fuel cell according to claim 1 wherein the loading of the catalyst on the cathode is about 0.10 mg or less of catalyst per square centimeter of projected surface area of the cathode.

12. A microbial fuel cell according to claim 1 claims which is capable of operating without the addition of a buffer.

13. A microbial fuel cell according to claim 1 wherein the anode is sheet-like shaped having a thickness of about 1 to about 10 mm.

14. A microbial fuel cell comprising:
A) an anode containing one or more electrically conductive materials which is arranged to provide flow paths for electrons through the electrically conductive material and to form flow paths for fluid material through passages formed in the electrically conductive material;
B) electrogenic microbes in electrical contact with the anode;
C) a cathode containing one or more conductive materials adapted such that the cathode can be contacted with an oxygen containing gas;
D) a separator disposed between the anode and the cathode having two opposing faces;
E) a conduit for electrons which forms a circuit in contact with both the anode and the cathode; and,
f) a means for introducing fluid material to the anode wherein the fluid flows through the anode in a direction substantially parallel to one of the faces of the separator.

15. A microbial fuel cell according to claim 1 wherein the anode comprises a bed of electrically conductive material, the fluid material contains biodegradable material and the fluid containing biodegradable material can flow through the anode and come into contact with the microbes in contact with the anode.

16. A microbial fuel cell according to claim 15 wherein the anode comprises porous electrical conductive materials having pores or a bed of particles or granules having particle sizes such that the fluid containing biodegradable material in the fluid can flow through the pores or bed or particles or granules.

17. A process comprising
A) providing a microbial fuel cell according to claim 1;
B) flowing the fluid containing biodegradable material through the anode in the presence of microbes;
C) contacting the cathode with an oxygen containing gas; and
D) removing from the location of the anode the fluid.

18. A process according to claim 17 wherein the fluid containing the biodegradable material is flowed continuously through the anode and the cathode is in constant contact with the oxygen containing gas.

19 A process according to claim 17 wherein the fuel cell is operated under conditions such that the fuel cell voltage is between 0.2 and 0.4 volts.

20. A microbial feel cell according to claim 1 wherein the mode is from 1 to 10 mm thick in the direction perpendicular to one of the faces of the separator.
